(19) United States
(12) Patent Application Publication
(10) Pub. No.: US 2026/0100558 A1
(43) Pub. Date: Apr. 9, 2026

(54) POWER DISTRIBUTION SYSTEM

(71) Applicant: AUO Corporation, Hsinchu City (TW)

(72) Inventors: Pei-Lun Chien, Hsinchu City (TW); Yu-Ju Chen, Hsinchu City (TW); Chih-Lin Chen, Hsinchu City (TW)

(73) Assignee: AUO Corporation, Hsinchu City (TW)

(21) Appl. No.: 18/953,090

(22) Filed: Nov. 20, 2024

Related U.S. Application Data
(60) Provisional application No. 63/704,048, filed on Oct. 7, 2024.

(30) Foreign Application Priority Data
Oct. 18, 2024 (TW) 113139731

(51) Int. Cl. H02B 1/04; H02B 1/20

(52) U.S. Cl. CPC H02B 1/04; H02B 1/20

(57) ABSTRACT

A power distribution system includes a frame, at least one busbar, and a plurality of switch modules. The busbar is disposed on the frame and is configured to be coupled to at least one input line. Each of the switch modules includes a switch module main body and a control unit, and the switch module main body is detachably disposed on the frame and has an input interface and an output interface. The input interface is coupled to the control unit and is connected to the busbar. The output interface is coupled to the control unit and is configured to be coupled to at least one output line. The control unit is disposed in the switch module main body and includes a relay and a control circuit board coupled to each other.

### CROSS-REFERENCE TO RELATED APPLICATION

This application claims the priority benefit of U.S. Provisional Application No. 63/704,048, filed on Oct. 7, 2024 and Taiwan Application No. 113139731, filed on Oct. 18, 2024. The entirety of each of the above-mentioned patent applications is hereby incorporated by reference herein and made a part of this specification.

### BACKGROUND

### Technical Field

The disclosure relates to a power system, and in particular, relates to a power distribution system.

### Description of Related Art

A conventional electrical panel is not equipped with intelligent control functions, so an intelligent control panel is required to be installed to provide measurement and control functions. Such an arrangement requires the installation of multiple intelligent control panels due to the large number of loops and is not suitable for outdoor installation or installation in places with limited space, and its wiring is complicated. At present, some integrated electrical panels include an electrical panel and an intelligent control panel, so there is no need to install an additional smart control panel. However, an integrated electrical panel has many parts and the assembly thereof is thus complicated. Further, the number of loops cannot be changed and multiple sets of molds must be developed to correspond to products with different numbers of loops, so production efficiency is low and high manufacturing costs are required. Further, whether it is a conventional electrical panel or an existing integrated electrical panels, its multiple switch components and multiple measurement components are not modularly designed individually, but share a single control circuit board. Therefore, when a single channel fails, the entire system must be dismantled for maintenance, resulting in low maintenance efficiency and a significant increase in the user's power outage time.

### SUMMARY

The disclosure provides a power distribution system capable of providing improved maintenance efficiency.

The disclosure provides a power distribution system including a frame, at least one busbar, and a plurality of switch modules. The busbar is disposed on the frame and is configured to be coupled to at least one input line. Each of the switch modules includes a switch module main body and a control unit, and the switch module main body is detachably disposed on the frame and has an input interface and an output interface. The input interface is coupled to the control unit and is connected to the busbar. The output interface is coupled to the control unit and is configured to be coupled to at least one output line. The control unit is disposed in the switch module main body and includes a relay and a control circuit board coupled to each other.

In an embodiment of the disclosure, each of the switch modules further includes a current sensor and a voltage measuring unit, and the current sensor and the voltage measuring unit are disposed in the switch module main body and are coupled to the control circuit board.

In an embodiment of the disclosure, the power distribution system further includes a plurality of connection terminals and a plurality of circuit breakers. The connection terminals are disposed on the frame and correspond to the switch modules. Each of the connection terminals is plugged into the output interface of the corresponding switch module. The circuit breakers are detachably disposed on the frame and are connected to the connection terminals. The output interface is coupled to the output line through the corresponding connection terminal and the corresponding circuit breaker.

In an embodiment of the disclosure, the frame includes a back plate and a base body connected to each other. The base body has a carrying surface and a bottom surface opposite to each other. An accommodation space is provided between the back plate and the bottom surface. The switch modules are disposed in the accommodation space, and the circuit breakers are disposed on the carrying surface.

In an embodiment of the disclosure, the switch module main body has two locking holes. The base body has as a plurality of openings corresponding to the locking holes of the switch module main bodies. Each of the switch modules further includes two locking members passing through the corresponding two openings to be locked to the two locking holes of the corresponding switch module main body and abutting against the busbar and the corresponding connection terminal.

In an embodiment of the disclosure, each of the circuit breakers is suitable for being separated from the base body to expose some of the openings.

In an embodiment of the disclosure, the back plate includes a plurality of sub-back plates detachably connected in sequence.

In an embodiment of the disclosure, the base body includes a plurality of sub-base bodies detachably connected in sequence.

In an embodiment of the disclosure, the back plate has a plurality of first sliding rails, and the base body has a plurality of second sliding rails. The switch module main body has a plurality of sliding grooves and is slidably disposed between one first sliding rail and one second sliding rail through the sliding grooves.

In an embodiment of the disclosure, the switch module main body has a hook engaged with the base body.

In an embodiment of the disclosure, the base body has a plurality of openings corresponding to the switch modules. The hook is suitable for being pressed through the corresponding opening to be detached from the base body.

In an embodiment of the disclosure, the accommodation space includes two adjacent sub-accommodation spaces. Some switch modules are arranged in sequence in one sub-accommodation space, and other switch modules are arranged in sequence in the other sub-accommodation space.

In an embodiment of the disclosure, the busbar has a plurality of first busbar terminals and a plurality of second busbar terminals. The first busbar terminals are plugged into the switch modules in one sub-accommodation space in a first direction, and the second busbar terminals are plugged into the switch modules in the other sub-accommodation space in a second direction opposite to the first direction.

In an embodiment of the disclosure, the power distribution system further includes a housing. In a width direction of the power distribution system, a size of the housing is W, a size of each switch module is L, an installation gap between each switch module and the housing is a, an installation width of the busbar is b, and W=4*L+2*a+b<362 mm.

In an embodiment of the disclosure, each of the connection terminals has a first end portion and a second end portion opposite to each other. The first end portion is connected to the corresponding circuit breaker. The second end portion is connected to the corresponding output interface. Each of the connection terminals is inserted into the base body so that the base body is located between the first end portion and the second end portion. The second end portion is located in the accommodation space. The busbar is disposed on the back plate and is located between the back plate and the second end portion.

In an embodiment of the disclosure, the frame further includes a plurality of supporting members supported between the back plate and the base body. Each of the supporting members is located between two adjacent switch modules.

In an embodiment of the disclosure, each of the supporting members is an I-shaped structure.

In an embodiment of the disclosure, the busbar includes a first phase busbar and a second phase busbar. The frame further includes at least one insulating column supported between the back plate and the base body and blocked between the first phase busbar and the second phase busbar.

In an embodiment of the disclosure, each of the switch modules is suitable for being independently detached and separated from the other switch modules, the circuit breakers, and the frame.

In an embodiment of the disclosure, the switch modules are coupled to each other via a daisy chain topology.

To sum up, the power distribution system of the disclosure includes a plurality of switch modules that are independent of each other. Each of these switch modules is provided with a control circuit board instead of sharing a single circuit board. Accordingly, when a single channel of the power distribution system fails, only the corresponding switch module can be removed for maintenance without the need to remove all switch modules as a whole, so the maintenance efficiency is improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a front view of a power distribution system according to an embodiment of the disclosure.

FIG. 2 is an exploded view of the power distribution system of FIG. 1.

FIG. 3 is an exploded view of some members of the power distribution system of FIG. 2.

FIG. 4 is a schematic diagram of the power distribution system of FIG. 1 connected to an input line and an output line.

FIG. 5 is a partial bottom view of the power distribution system of FIG. 1.

FIG. 6 is a partial structure of the power distribution system of FIG. 3.

FIG. 7 is a partial structure of the power distribution system of FIG. 3.

FIG. 8 is an exploded view of some members of the power distribution system of FIG. 7.

FIG. 9 illustrates an internal structure of a switch module of FIG. 5.

FIG. 10 and FIG. 11 are three-dimensional views of some members of the power distribution system of FIG. 7 at different viewing angles.

FIG. 12 is a front view of the switch module of FIG. 6.

FIG. 13 is a front view of a partial structure of the power distribution system of FIG. 6.

FIG. 14 is a side view of a partial structure of the power distribution system of FIG. 6.

FIG. 15 is a cross-sectional view of the power distribution system of FIG. 13 taken along line I-I.

FIG. 16 is a front view of a partial structure of the power distribution system of FIG. 15.

FIG. 17 is a partial three-dimensional view of some members of the power distribution system of FIG. 6.

FIG. 18 is a partial three-dimensional view of some members of the power distribution system of FIG. 17.

FIG. 19 is a partial three-dimensional view of some members of the power distribution system of FIG. 6.

FIG. 20 is a front view of the power distribution system of FIG. 19.

FIG. 21 is a partial side view of some members of the power distribution system of FIG. 6.

FIG. 22 illustrates a partial structure of a base body of FIG. 3.

FIG. 23 is a partial enlarged view of the base body of FIG. 22.

FIG. 24A and FIG. 24B illustrate an assembly method of a sub-base body of FIG. 22.

FIG. 25 illustrates a partial structure of a back plate of FIG. 3.

FIG. 26 illustrates two switch modules of FIG. 5 being moved away from two sub-accommodation spaces.

### DESCRIPTION OF THE EMBODIMENTS

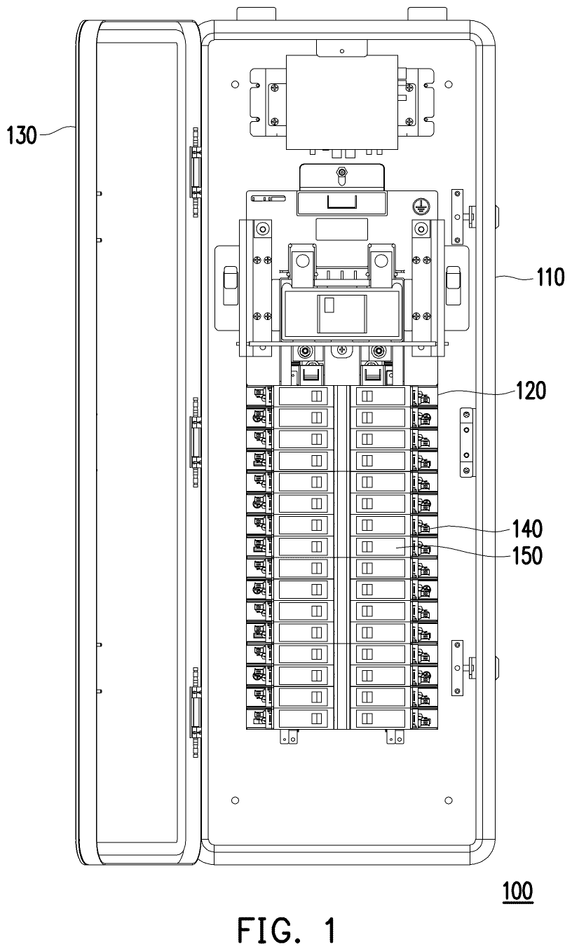

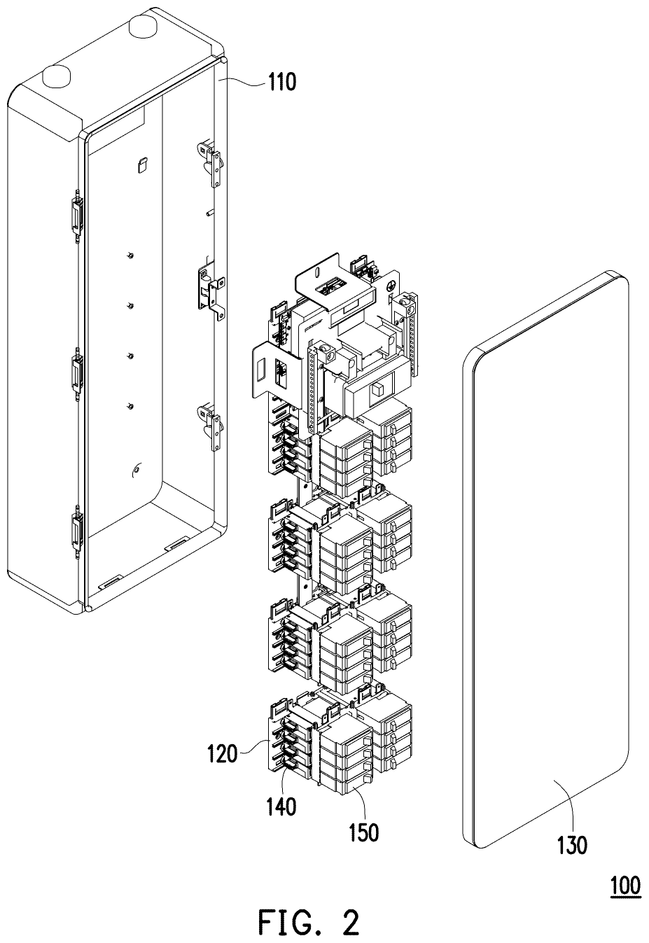

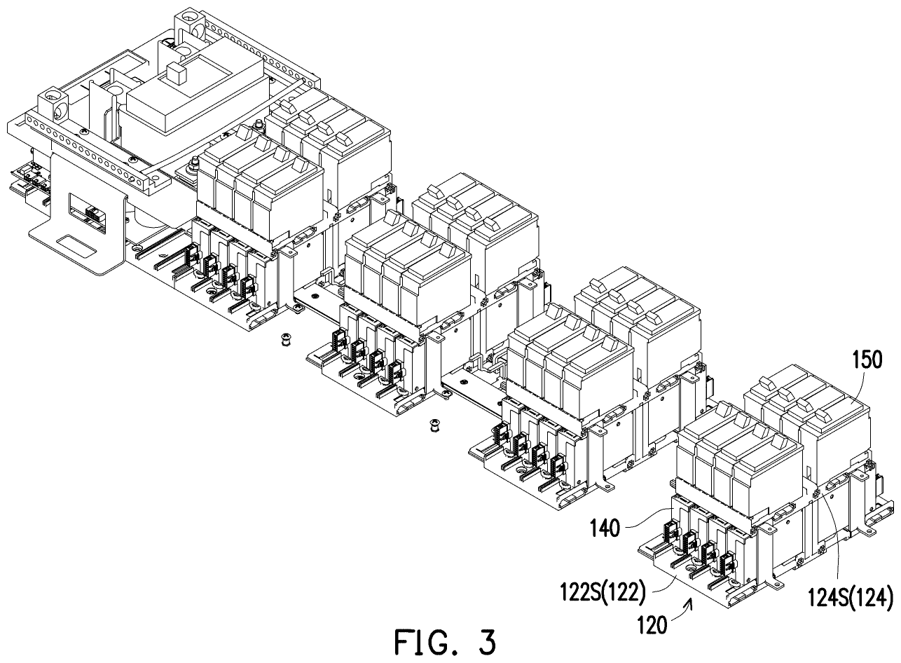

FIG. 1 is a front view of a power distribution system according to an embodiment of the disclosure. FIG. 2 is an exploded view of the power distribution system of FIG. 1. FIG. 3 is an exploded view of some members of the power distribution system of FIG. 2. With reference to FIG. 1 to FIG. 3, a power distribution system 100 of this embodiment includes a housing 110, a frame 120, a cover 130, a plurality of switch modules 140, and a plurality of circuit breakers 150. The frame 120 is disposed in the housing 110 and is configured to carry the switch modules 140 and the circuit breakers 150. The cover 130 is pivotally connected to the housing 110 and is configured to cover the housing 110 to cover the frame 120, the switch modules 140, the circuit breakers 150, and other members in the housing 110.

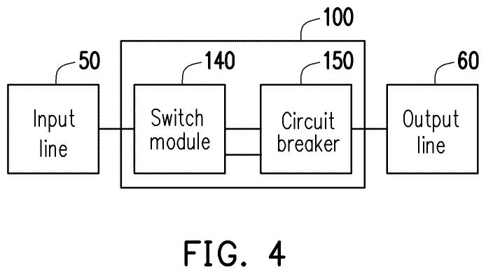

FIG. 4 is a schematic diagram of the power distribution system of FIG. 1 connected to an input line and an output line. With reference to FIG. 4, an input line 50 (e.g., an alternating current (AC) line) is used to input power to the switch module 140, and the power is outputted from the switch module 140 to an output line 60 (e.g., an AC line) through the circuit breaker 150.

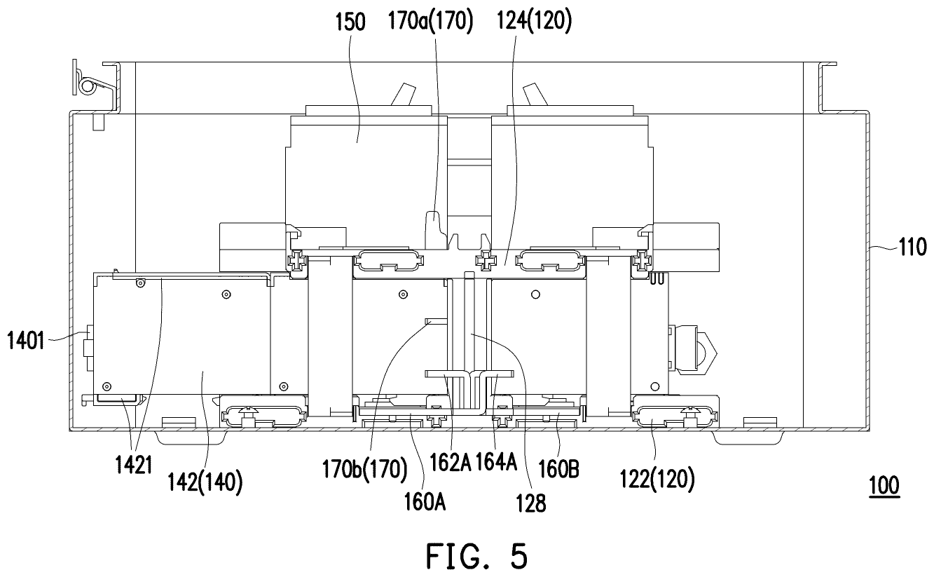

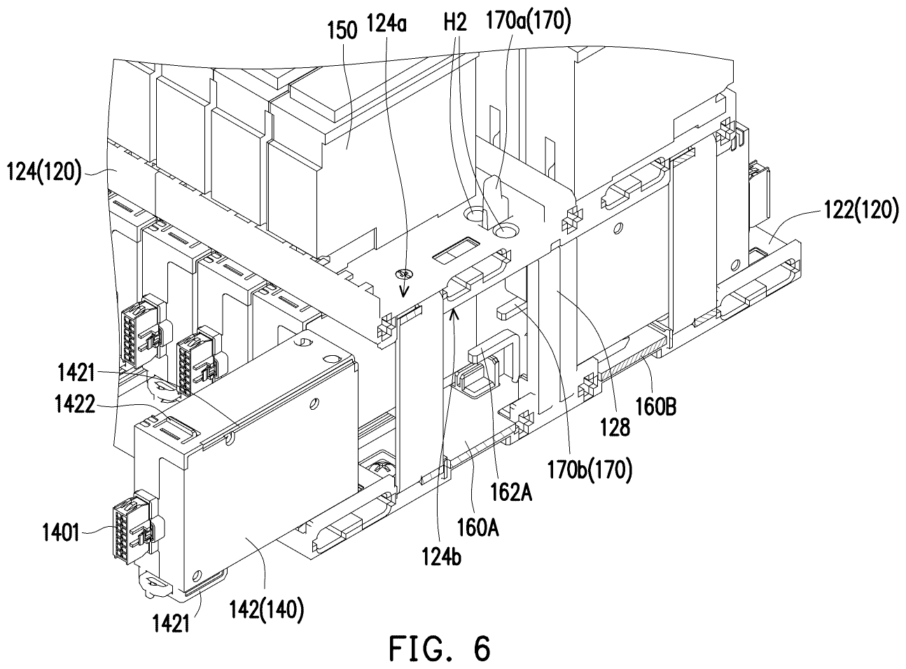

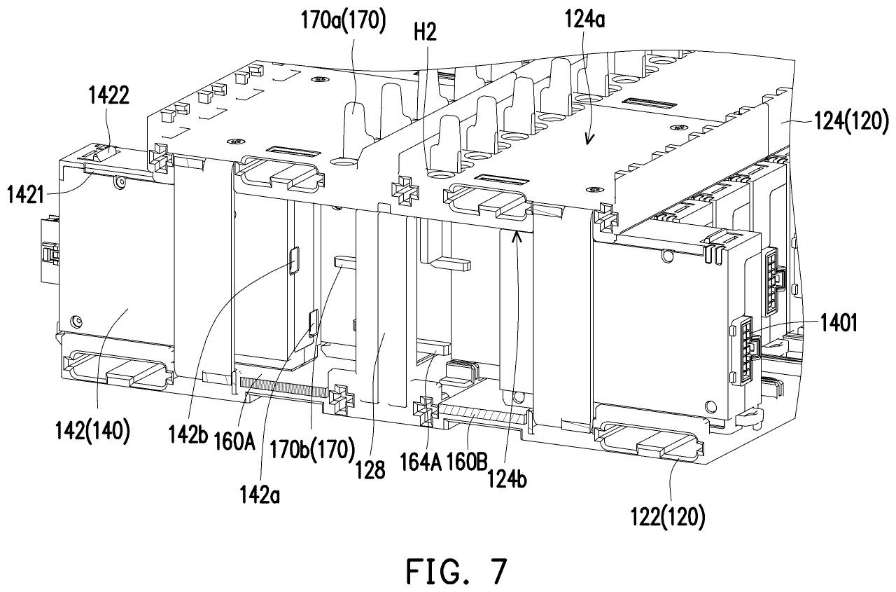

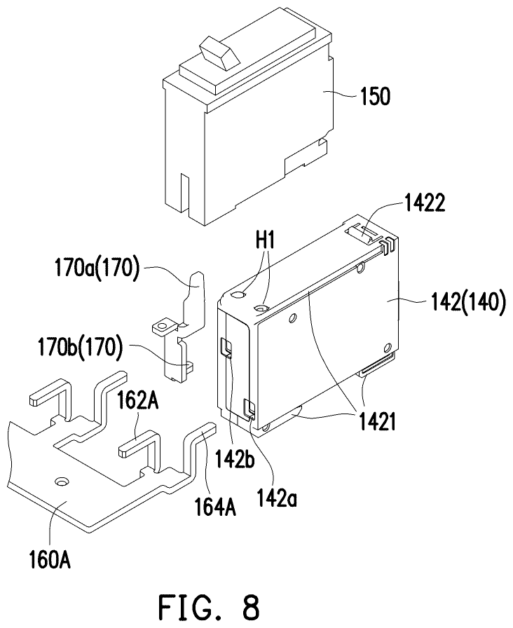

FIG. 5 is a partial bottom view of the power distribution system of FIG. 1, FIG. 6 is a partial structure of the power distribution system of FIG. 3, and FIG. 7 is a partial structure of the power distribution system of FIG. 3. To make the drawings clearer, part of the switch module 140 and part of the circuit breaker 150 in FIG. 5 to FIG. 7 are shown in a removed state. FIG. 8 is an exploded view of some members of the power distribution system of FIG. 7. With reference to FIG. 5 to FIG. 8, to be specific, each switch module 140 of this embodiment includes a switch module main body 142 detachably disposed on the frame 120 and having an input interface 142a and an output interface 142b. The power distribution system 100 further includes at least one busbar (shown as a first phase busbar 160A and a second phase busbar 160B) and a plurality of connection terminals 170. The first phase busbar 160A and the second phase busbar 160B are disposed on the frame 120 and are configured to be coupled to the input line 50 shown in FIG. 2. The input interfaces 142a of some of the switch module main bodies 142 are connected to the first phase busbar 160A, and the input interfaces 142a of other switch module main bodies 142 are connected to the second phase busbar 160B.

The connection terminals 170 are disposed on the frame 120 and correspond to the switch modules 140. Each connection terminal 170 is plugged into the output interface 142b of the switch module main body 142 of the corresponding switch module 140. The circuit breakers 150 are detachably disposed on the frame 120 and are connected to the connection terminals 170. The output interface 142b of each switch module main body 142 is coupled to the output line 60 shown in FIG. 2 through the corresponding connection terminal 170 and the corresponding circuit breaker 150. In addition, these switch modules 140 are coupled to each other, for example, via connection ports 1401 through a daisy chain topology, so that signals and power may be transmitted therebetween.

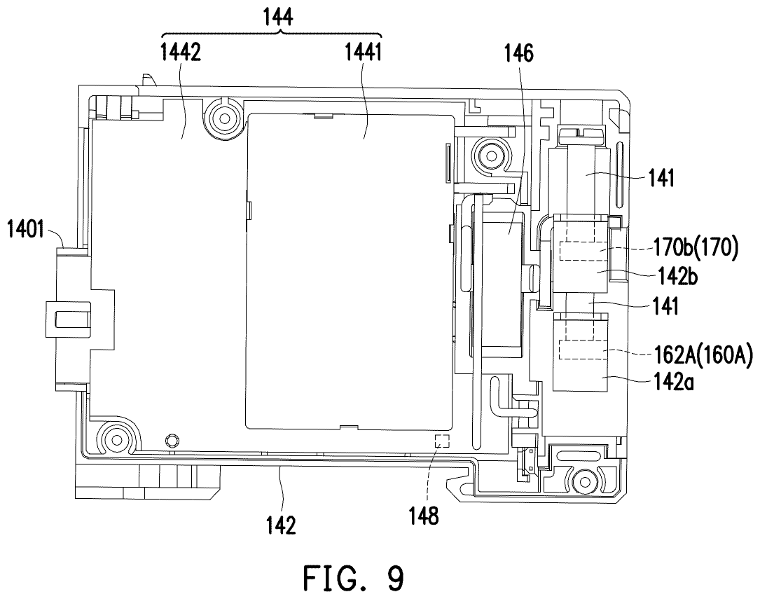

FIG. 9 illustrates an internal structure of a switch module of FIG. 5. With reference to FIG. 9, each switch module 140 of this embodiment further includes a control unit 144 disposed in the switch module main body 142. The input interface 142a and the output interface 142b of the switch module main body 142 are coupled to the control unit 144. The control unit 144 includes a relay 1441 and a control circuit board 1442 coupled to each other. Further, each switch module 140 further includes a current sensor 146 and a voltage measuring unit 148. The current sensor 146 and the voltage measuring unit 148 are disposed in the switch module main body 142 and coupled to the control circuit board 1442. To be specific, the power enters the switch module 140 from the input interface 142a, reaches the relay 1441, reaches the current sensor 146 through the control circuit board 1442, and then reaches the output interface 142b through the control circuit board 1442. The relay 1441 is configured to switch the power transmission of the switch module 140. The current sensor 146 is configured to sense the current. The voltage measuring unit 148 is configured to measure voltage. The control circuit board 1442 is configured to control at least a part of the switch module 140 including the various functions mentioned above. The detailed functions and working principles of the control circuit board 1442, the relay 1441, the current sensor 146, and the voltage measuring unit 148 are known technologies in the field of electrical panels and are not elaborated here.

Compared to a conventional electrical panel, at least one feature of the power distribution system 100 of this embodiment is that the power distribution system 100 includes a plurality of switch modules 140 that are independent of each other as described above. These switch modules 140 are each provided with the control circuit board 1442 integrated with the voltage measuring unit 148, rather than sharing a single circuit board. Therefore, each switch module 140 may be independently detached and separated from other switch modules 140, the circuit breakers 150, and the frame 120. Accordingly, when a single channel of the power distribution system 100 fails, only the corresponding switch module 140 can be removed for maintenance without the need to remove all switch modules 140 as a whole, so maintenance efficiency is thereby improved.

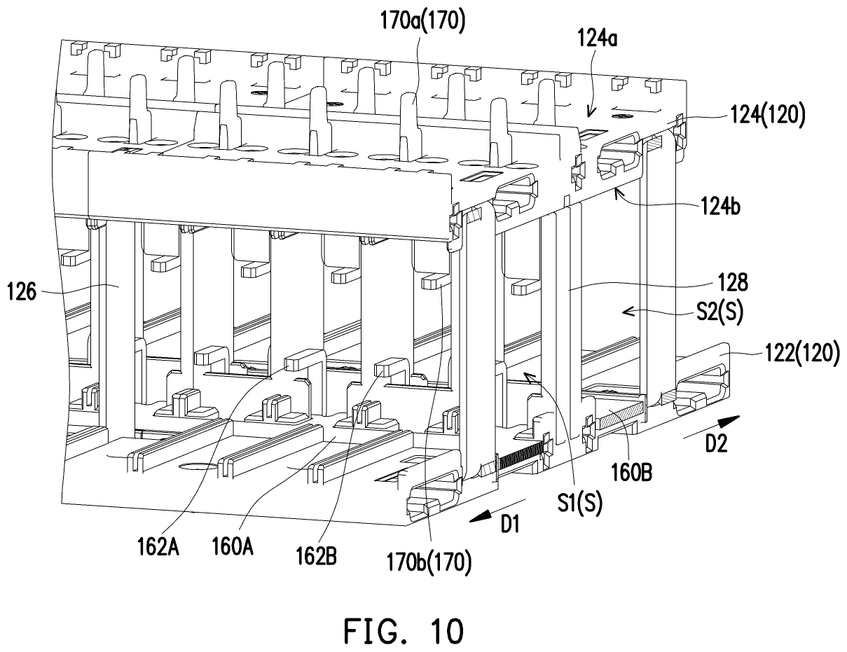

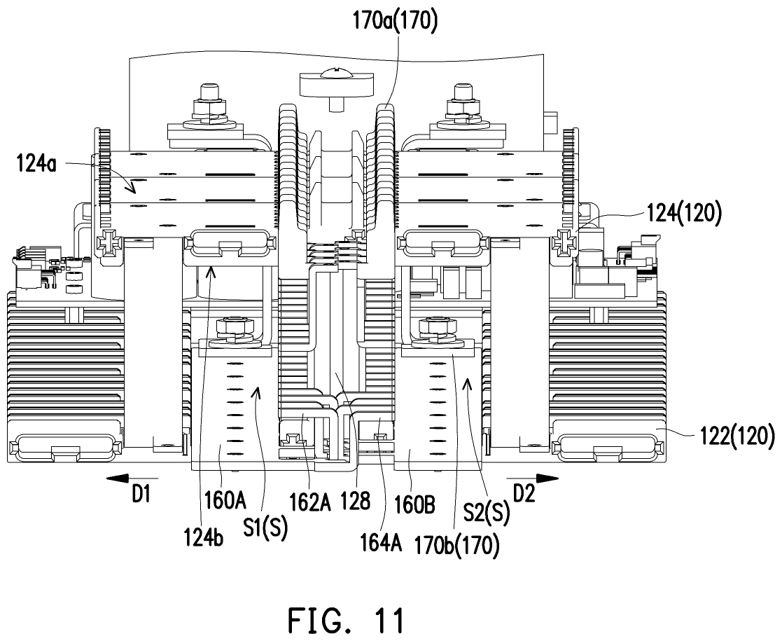

FIG. 10 and FIG. 11 are three-dimensional views of some members of the power distribution system of FIG. 7 at different viewing angles. With reference to FIG. 7, FIG. 10, and FIG. 11, in this embodiment, the frame 120 includes a back plate 122 and a base body 124 connected to each other. The base body 124 has a carrying surface 124a and a bottom surface 124b opposite to each other. An accommodation space S is provided between the back plate 122 and the bottom surface 124b of the base body 124. The switch modules 140 are disposed in the accommodation space S, and the circuit breakers 150 are disposed on the carrying surface 124a of the base body 124. Further, each of the connection terminals 170 has a first end portion 170a and a second end portion 170b opposite to each other. The first end portion 170a is connected to the corresponding circuit breaker 150, and the second end portion 170b is connected to the output interface 142b of the corresponding switch module 140. Each of the connection terminals 170 is inserted into the base body 124 so that the base body 124 is located between the first end portion 170a and the second end portion 170b. The second end portion 170b is located in the accommodation space S. The first phase busbar 160A and the second phase busbar 160B are disposed on the back plate 122 and located between the back plate 122 and the second end portion 170b.

With this arrangement, the frame 120 forms a double-layer open installation structure with its back plate 122 and the base body 124. Further, the at least one busbar (the first phase busbar 160A and the second phase busbar 160B) and the first end portion 170a and the second end portion 170b of the connection terminal 170 form a three-layer external terminal. Therefore, the circuit breaker 150 and the switch module 140 may be conveniently installed on an upper layer and a lower layer of the frame 120 respectively and may be electrically connected to the connection terminal 170 smoothly through the at least one busbar (the first phase busbar 160A and the second phase busbar 160B).

Further, the accommodation space S of this embodiment includes two adjacent sub-accommodation space S1 and S2. Some switch modules 140 are arranged in sequence in the sub-accommodation space S1, and other switch modules 140 are arranged in sequence in the sub-accommodation space S2. The first phase busbar 160A has a plurality of first busbar terminals 162A and a plurality of second busbar terminals 164A as shown in FIG. 11. The first busbar terminals 162A are plugged into some switch modules 140 in the sub-accommodation space S1 in a first direction D1. The second busbar terminals 164A are plugged into some switch modules 140 in the sub-accommodation space S2 in a second direction D2 opposite to the first direction D1. Similarly, the second phase busbar 160B has a plurality of first busbar terminals 162B and a plurality of second busbar terminals 164B as shown in FIG. 11. The first busbar terminals 162B are plugged into some switch modules 140 in the sub-accommodation space S1 in the first direction D1. The second busbar terminals 164B are plugged into some switch modules 140 in the sub-accommodation space S2 in the second direction D2. With this arrangement, the at least one busbar (the first phase busbar 160A and the second phase busbar 160B) and the switch module 140 are compactly arranged in the accommodation space S, so that an arrangement space is saved, and a volume of the entire device is reduced.

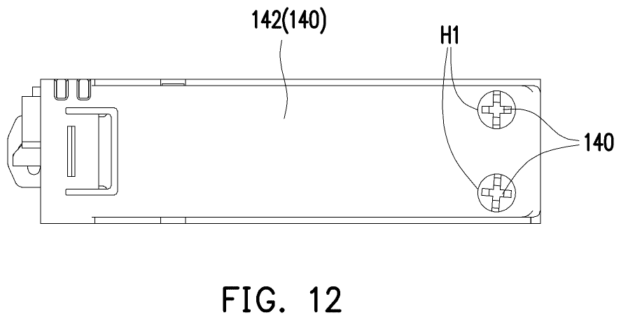

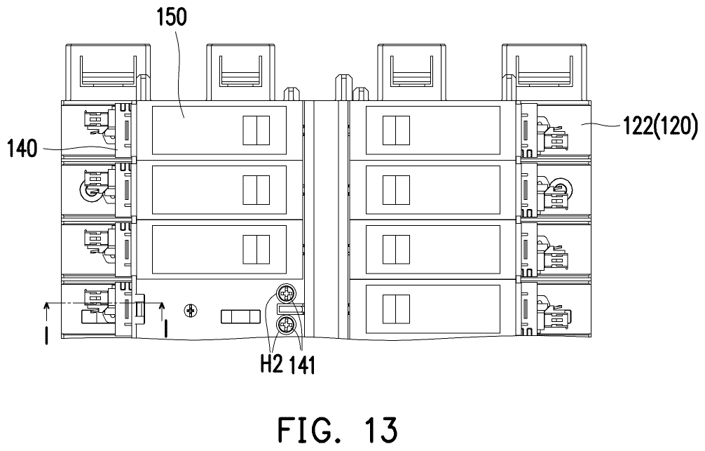

FIG. 12 is a front view of the switch module of FIG. 6. FIG. 13 is a front view of a partial structure of the power distribution system of FIG. 6. With reference to FIG. 6, FIG. 7, FIG. 12, and FIG. 13, each switch module main body 142 of this embodiment has two locking holes H1. The base body 124 has as a plurality of openings H2 corresponding to the locking holes H1 of the switch module main bodies 142. Each of the circuit breakers 150 is suitable for being separated from the base body 124 to expose some of the openings H2. Each of the switch modules 140 further includes two locking members 141 (shown in FIG. 12 and FIG. 13) passing through the corresponding two openings H2 to be locked to the two locking holes H1 of the corresponding switch module main body 142 and abutting against the terminals (shown as the first busbar terminals 162A of the first phase busbar 160A) of the corresponding busbar and the second end portion 170b of the corresponding connection terminal 170.

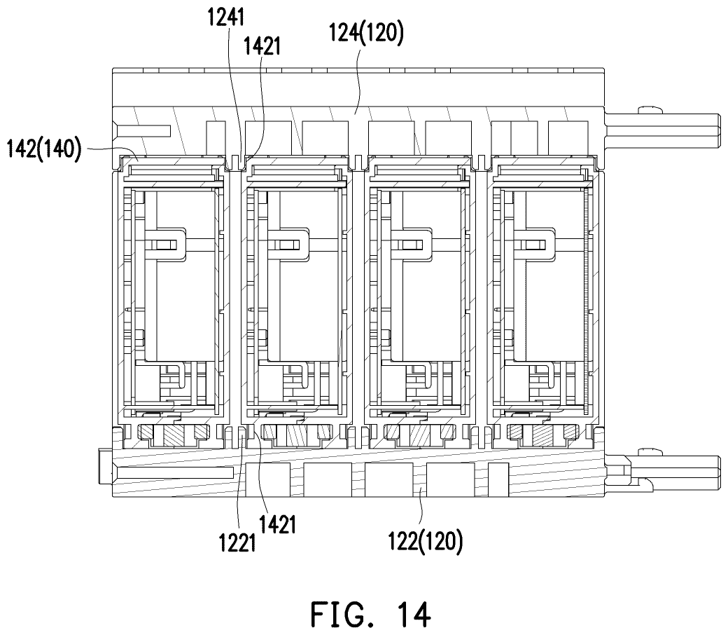

FIG. 14 is a side view of a partial structure of the power distribution system of FIG. 6. With reference to FIG. 8 and FIG. 14, the back plate 122 of this embodiment as a plurality of first sliding rails 1221, and the base body 124 has a plurality of second sliding rails 1241. The switch module main body 142 has a plurality of sliding grooves 1421 and is slidably disposed between one first sliding rail 1221 and one second sliding rail 1241 through the sliding grooves 1421. Accordingly, each switch module main body 142 may be smoothly installed on the frame 120 by being guided by the first sliding rails 1221 and the second sliding rails 1241.

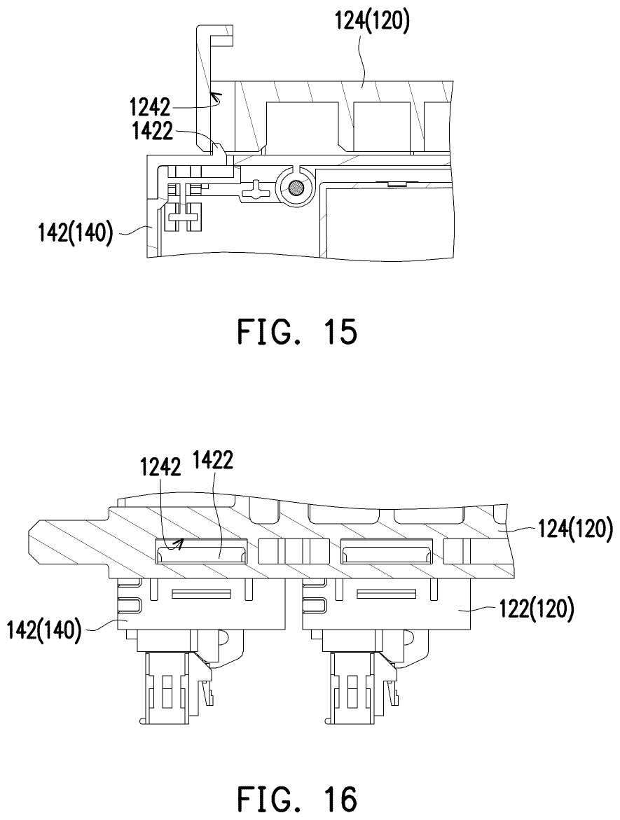

FIG. 15 is a cross-sectional view of the power distribution system of FIG. 13 taken along line I-I. FIG. 16 is a front view of a partial structure of the power distribution system of FIG. 15. With reference to FIG. 15 and FIG. 16, each switch module main body 142 has a hook 1422, the base body 124 has a plurality of openings 1242, and these openings 1242 correspond to these switch modules 140. The hooks 1422 are engaged with the openings 1242 of the base 124 so that the switch module main bodies 142 are stably installed on the frame 120. The hook 1422 is suitable for being pressed through the corresponding opening 1242 to be separated from the base body 124, so that the switch module main body 142 may be removed from the frame 120.

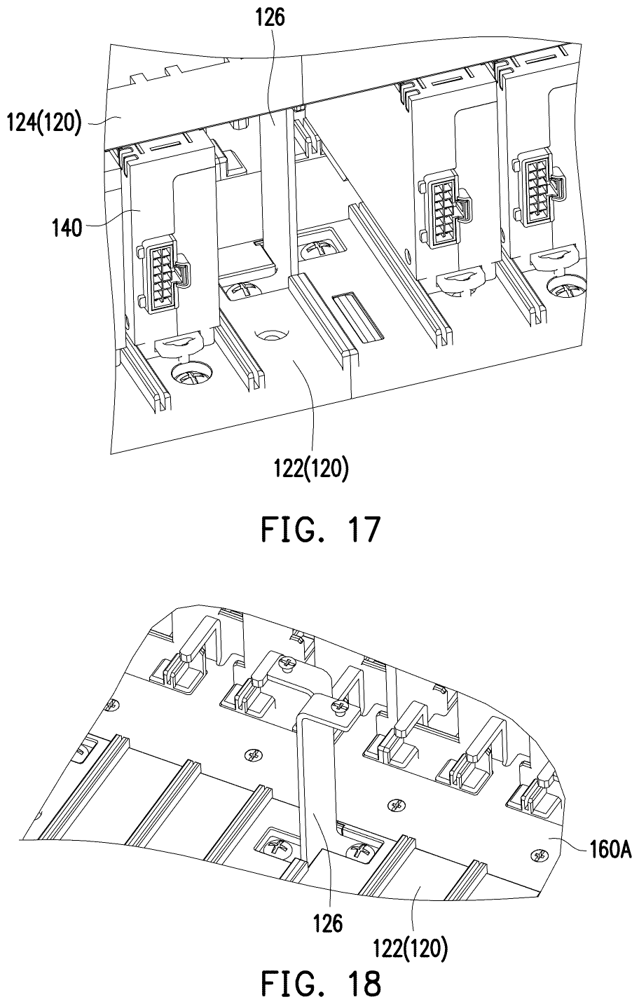

FIG. 17 is a partial three-dimensional view of some members of the power distribution system of FIG. 6. FIG. 18 is a partial three-dimensional view of some members of the power distribution system of FIG. 17. With reference to FIG. 17 and FIG. 18, the frame 120 of this embodiment further includes a plurality of supporting members 126 supported between the back plate 122 and the base body 124. As shown in FIG. 18, each supporting member 126 is an I-shaped structure with a small thickness. Each supporting member 126 may be disposed between two adjacent switch modules 140 without excessively occupying the arrangement spaces of the switch modules 140.

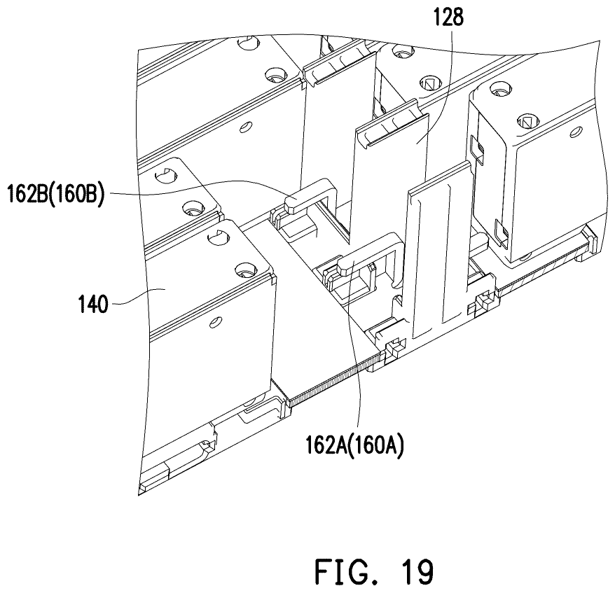

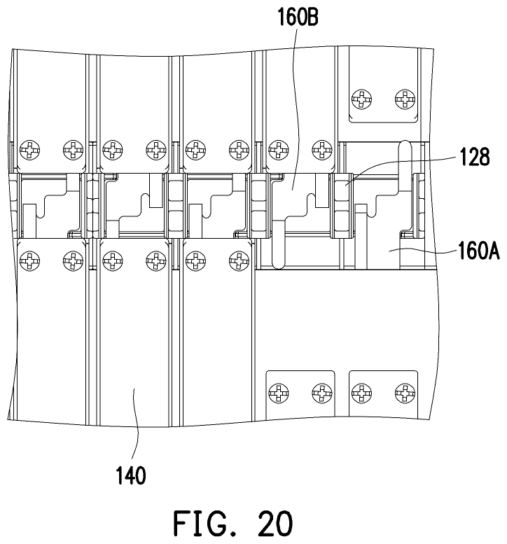

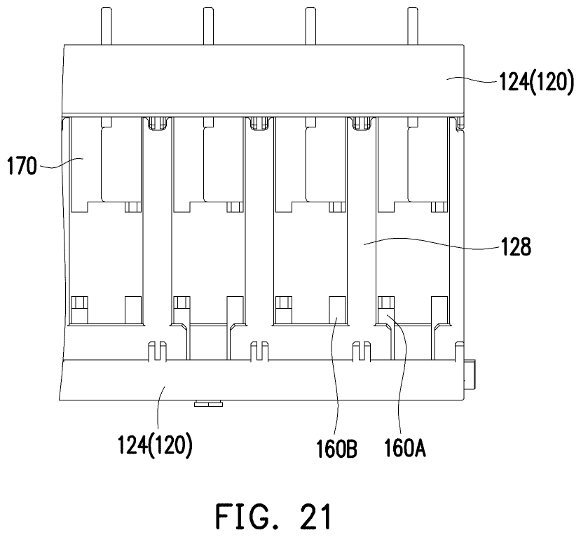

FIG. 19 is a partial three-dimensional view of some members of the power distribution system of FIG. 6. FIG. 20 is a front view of the power distribution system of FIG. 19. FIG. 21 is a partial side view of some members of the power distribution system of FIG. 6. With reference to FIG. 19 to FIG. 21, the frame 120 of this embodiment further includes a plurality of insulating columns 128 supported between the back plate 122 and the base body 124 and blocked between the terminals (the first busbar terminals 162A and the second busbar terminals 162B) of the first phase busbar 160A and the terminals (the first busbar terminals 164A and the second busbar terminals 164B) of the second phase busbar 160B. As described above, the insulating columns 128 have the functions of both structural support and electrical isolation of different phases, so that the structural design of the frame 120 may be simplified, and the arrangement space may be saved.

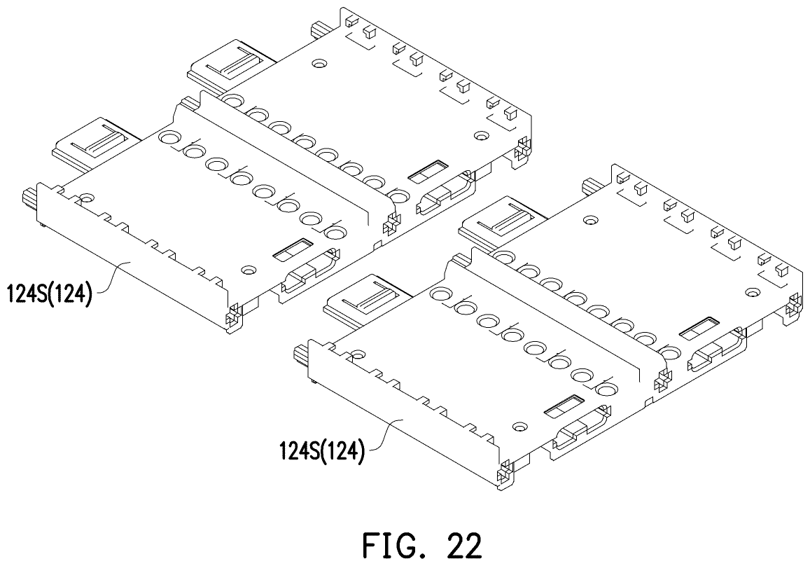

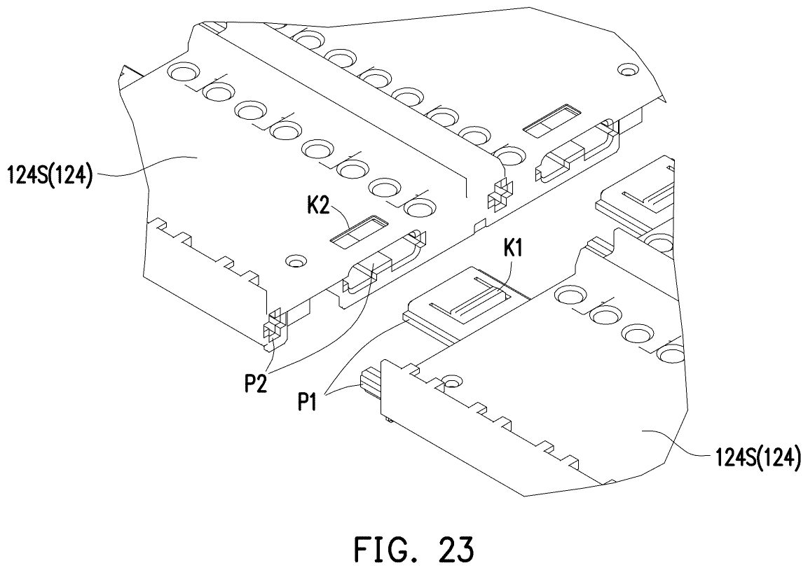

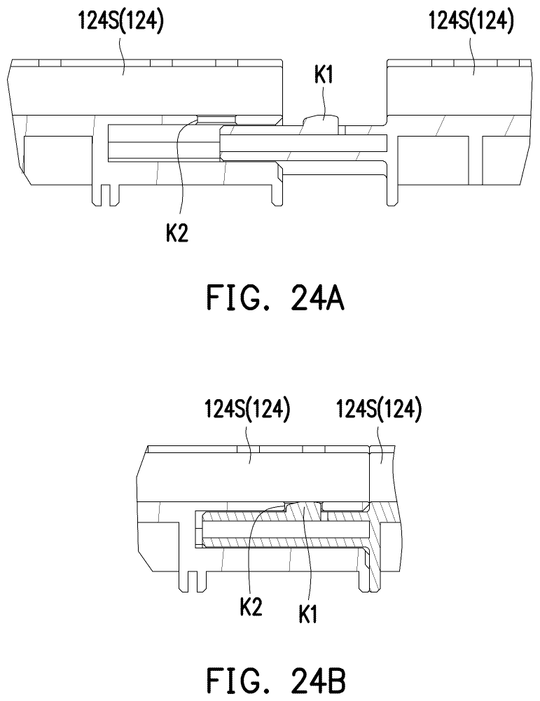

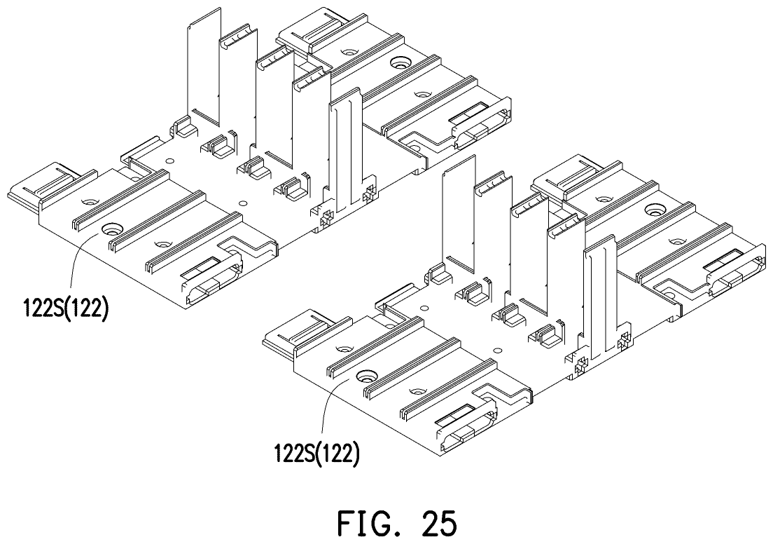

FIG. 22 illustrates a partial structure of a base body of FIG. 3. FIG. 23 is a partial enlarged view of the base body of FIG. 22. FIG. 24A and FIG. 24B illustrate an assembly method of a sub-base body of FIG. 22. With reference to FIG. 3 and FIG. 22 to FIG. 24B, the base body 124 of this embodiment includes a plurality of sub-base bodies 124S detachably connected in sequence. To be specific, a pin P1 (marked in FIG. 23) of each sub-base body 124S may be inserted into a pin hole P2 (marked in FIG. 23) of another sub-base body 124S. Further, a hook K1 of each sub-base body 124S may be buckled into a buckle groove K2 of another sub-base body 124S as shown in FIG. 24A to FIG. 24B, so that the connection of the two sub-base bodies 124S may be quickly completed without other fasteners. FIG. 25 illustrates a partial structure of a back plate of FIG. 3. Similarly, the back plate 122 of this embodiment includes a plurality of sub-back plates 122S detachably connected in sequence. The joining method thereof is the same or similar to that of the sub-base body 124S so description thereof is not repeated herein. With this arrangement, a user can change the number of sub-base bodies 124S and sub-back plates 122S according to the number of loops required in the power distribution system, so as to flexibly expand the number of loops and easily meet customized needs.

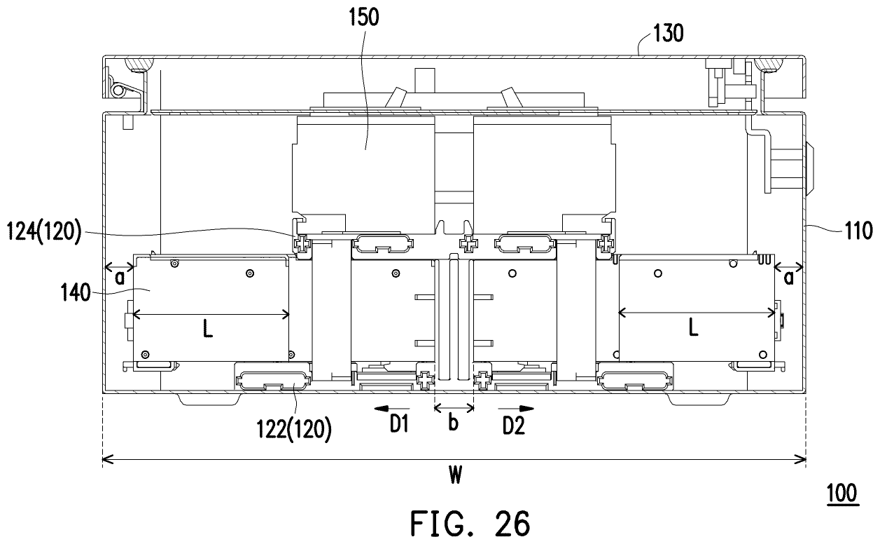

FIG. 26 illustrates two switch modules of FIG. 5 being moved away from two sub-accommodation spaces. With reference to FIG. 26, in a width direction of the power distribution system 100 parallel to the first direction D1 and the second direction D2, a size of the housing 110 is W, a size of each switch module 140 is L, an installation gap between each switch module 140 and the housing 110 is a, an installation width of the at least one busbar is b, and W=4*L+2*a+b<362 mm (the common width of European and American distribution boards). In this way, the switch module 140 may have enough space for removal while the width of the housing 110 is reduced as much as possible.

In view of the foregoing, the power distribution system of the disclosure includes a plurality of switch modules that are independent of each other. Each of these switch modules is provided with a control circuit board instead of sharing a single circuit board. Accordingly, when a single channel of the power distribution system fails, only the corresponding switch module can be removed for maintenance without the need to remove all switch modules as a whole, so the maintenance efficiency is improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A power distribution system, comprising:
a frame;
at least one busbar disposed on the frame and configured to be coupled to at least one input line; and
a plurality of switch modules, wherein each of the switch modules comprises a switch module main body and a control unit, the switch module main body is detachably disposed on the frame and has an input interface and an output interface, the input interface is coupled to the control unit and is connected to the at least one busbar, the output interface is coupled to the control unit and is configured to be coupled to at least one output line, and the control unit is disposed in the switch module main body and comprises a relay and a control circuit board coupled to each other.

2. The power distribution system according to claim 1, wherein each of the switch modules further comprises a current sensor and a voltage measuring unit, and the current sensor and the voltage measuring unit are disposed in the switch module main body and are coupled to the control circuit board.

3. The power distribution system according to claim 1, further comprising a plurality of connection terminals and a plurality of circuit breakers, wherein the connection terminals are disposed on the frame and correspond to the switch modules, each of the connection terminals is plugged into the output interface of the corresponding switch module, the circuit breakers are detachably disposed on the frame and are connected to the connection terminals, and the output interface is coupled to the at least one output line through the corresponding connection terminal and the corresponding circuit breaker.

4. The power distribution system according to claim 3, wherein the frame comprises a back plate and a base body connected to each other, the base body has a carrying surface and a bottom surface opposite to each other, an accommodation space is provided between the back plate and the bottom surface, the switch modules are disposed in the accommodation space, and the circuit breakers are disposed on the carrying surface.

5. The power distribution system according to claim 4, wherein the switch module main body has two locking holes, the base body has as a plurality of openings corresponding to the locking holes of the switch module main bodies, and each of the switch modules further comprises two locking members passing through the corresponding two openings to be locked to the two locking holes of the corresponding switch module main body and abutting against the at least one busbar and the corresponding connection terminal.

6. The power distribution system according to claim 5, wherein each of the circuit breakers is suitable for being separated from the base body to expose some of the openings.

7. The power distribution system according to claim 4, wherein the back plate comprises a plurality of sub-back plates detachably connected in sequence.

8. The power distribution system according to claim 4, wherein the base body comprises a plurality of sub-base bodies detachably connected in sequence.

9. The power distribution system according to claim 4, wherein the back plate has a plurality of first sliding rails, the base body has a plurality of second sliding rails, and the switch module main body has a plurality of sliding grooves and is slidably disposed between one first sliding rail and one second sliding rail through the sliding grooves.

10. The power distribution system according to claim 4, wherein the switch module main body has a hook engaged with the base body.

11. The power distribution system according to claim 10, wherein the base body has a plurality of openings corresponding to the switch modules, and the hook is suitable for being pressed through the corresponding opening to be detached from the base body.

12. The power distribution system according to claim 4, wherein the accommodation space comprises two adjacent sub-accommodation spaces, some switch modules are arranged in sequence in one sub-accommodation space, and other switch modules are arranged in sequence in the other sub-accommodation space.

13. The power distribution system according to claim 12, wherein the at least one busbar has a plurality of first busbar terminals and a plurality of second busbar terminals, the first busbar terminals are plugged into the switch modules in one sub-accommodation space in a first direction, and the second busbar terminals are plugged into the switch modules in the other sub-accommodation space in a second direction opposite to the first direction.

14. The power distribution system according to claim 12, further comprising a housing, wherein in a width direction of the power distribution system, a size of the housing is W, a size of each switch module is L, an installation gap between each switch module and the housing is a, an installation width of the at least one busbar is b, and W=4*L+2*a+b<362 mm.

15. The power distribution system according to claim 4, wherein each of the connection terminals has a first end portion and a second end portion opposite to each other, the first end portion is connected to the corresponding circuit breaker, the second end portion is connected to the corresponding output interface, each of the connection terminals is inserted into the base body so that the base body is located between the first end portion and the second end portion, the second end portion is located in the accommodation space, and the at least one busbar is disposed on the back plate and is located between the back plate and the second end portion.

16. The power distribution system according to claim 4, wherein the frame further comprises a plurality of supporting members supported between the back plate and the base body, and each of the supporting members is located between two adjacent switch modules.

17. The power distribution system according to claim 16, wherein each of the supporting members is an I-shaped structure.

18. The power distribution system according to claim 4, wherein the at least one busbar comprises a first phase busbar and a second phase busbar, the frame further comprises at least one insulating column supported between the back plate and the base body and blocked between the first phase busbar and the second phase busbar.

19. The power distribution system according to claim 3, wherein each of the switch modules is suitable for being independently detached and separated from the other switch modules, the circuit breakers, and the frame.

20. The power distribution system according to claim 1, wherein the switch modules are coupled to each other via a daisy chain topology.
